(19) United States
(12) Patent Application Publication
(10) Pub. No.: US 2026/0127778 A1
(43) Pub. Date: May 7, 2026

(54) MOBILE ACTIVE DECOY SYSTEM AND METHOD

(71) Applicant: ROCKWELL COLLINS, INC., Cedar Rapids, IA (US)

(72) Inventors: Martin J. JENNINGS, Cedar Rapids, IA (US); Andrew W. JENNINGS, Cedar Rapids, IA (US)

(73) Assignee: ROCKWELL COLLINS, INC., Cedar Rapids, IA (US)

(21) Appl. No.: 18/934,410

(22) Filed: Nov. 1, 2024

(51) Int. Cl. G06T 11/00; G01S 17/86; G01S 17/89

(52) U.S. Cl. CPC G06T 11/00; G01S 17/86; G01S 17/89

(57) ABSTRACT

A mobile active decoy system (MADS) is positioned above an area of terrain to obfuscate features in the area from data gathering by other entities. The MADS includes a laser-imaging, detection and ranging (LiDAR) system that scans the area of the terrain to capture topography data. The MADS also includes one or more cameras to capture infrared, visual, and ultraviolet data within the area of the terrain that defines one or more features in the area. A terrain evaluation function defines a topography of the terrain using the topography data. A graphics engine generates a decoy image using the topography of the terrain and data of the features captured by the camera. A projection system projects the decoy image to overlay it on the terrain to obfuscate the one or more features within the area.

### FIELD OF THE INVENTION

The subject matter disclosed herein relates to a mobile active decoy system. In particular, to the subject matter relates to a mobile active decoy system that deceives an adversary that depends on surveillance for data gathering.

### BACKGROUND OF THE INVENTION

Military superiority has been achieved in part by surveying the enemy and outperforming their observed capabilities. Observation may be one of the most crucial tools in strategic operations. To gain the tactical advantage, one should inhibit an enemy's ability to observe. This objective can be achieved through offensive action such as destroying their surveying capability, or passively by obfuscating the observable data. Obfuscation often is the more desirable approach because through misleading information, an opponent drains their own resources (fuel, manpower, weaponry, and the like) while at the same time keeping one's own forces out of harm's way.

It may be appreciated that there is a need to provide visual obfuscation using visual and electronic deception for deployment in various situations to misdirect and confuse the enemy.

### SUMMARY OF THE INVENTION

The present disclosure is directed, in a first aspect, to a mobile active decoy system (MADS). The MADS includes a laser-imaging, detection and ranging (LiDAR) system to scan an area of a terrain to capture topography data. The MADS also includes at least one camera to capture data of at least one feature within the area. The MADS also includes a terrain evaluation function to define a topography of the terrain using the topography data. The MADS also includes a graphics engine to generate a decoy image using the topography of the terrain and the data of the at least one feature. The MADS also includes a projection system to project and overlay the decoy image onto the area of the terrain.

In yet another embodiment, the present disclosure is directed to a mobile active decoy system (MADS) configuration. The MADS configuration includes a first MADS platform having a first MADS. The first MADS includes a laser-imaging, detection and ranging (LiDAR) system to scan a first area of a terrain to capture topography data. The first MADS also includes at least one camera to capture data of at least one feature within the first area. The first MADS also includes a terrain evaluation function to define a topography of the terrain within the first area using the topography data. The first MADS also includes a graphics engine to generate a first decoy image using the topography of the terrain and the data of the at least one feature. The first MADS also includes a projection system to project and overlay the first decoy image onto the first area of the terrain. The MADS configuration also includes a second MADS platform having a second MADS. The second MADS includes a LiDAR system to scan a second area of the terrain to capture topography data. The second area is not located within the first area. The second MADS also includes at least one camera to capture data of at least one feature within the second area. The second MADS also includes a terrain evaluation function to define a topography of the terrain within the second area using the topography data. The second MADS also includes a graphics engine to generate a second decoy image using the topography of the terrain and the data of the at least one feature. The second MADS also includes a projection system to project and overlay the second decoy image onto the second area of the terrain.

In yet another embodiment, the present disclosure is directed to a method for performing visual obfuscation of a terrain. The method includes scanning an area of the terrain using a laser-imaging, detection and ranging (LiDAR) system of a mobile active decoy system (MADS) positioned above the area of the terrain to capture topography data of the area. The method also includes capturing data of at least one feature of the area using at least one camera of the MADS. The method also includes defining a topography of the terrain within the area using a terrain evaluation function of the MADS and the topography data. The method also includes generating a decoy image using a graphics engine of the MADS based on a user defined image. The graphics engine receives the topography of the terrain and the captured data of the at least one feature to adjust the user defined image to generate the decoy image. The method also includes projecting the decoy image from a projection system of the MADS to overlay the decoy image onto the terrain. The decoy image obfuscates the terrain.

### BRIEF DESCRIPTION OF FIGURES

The features of the disclosure believed to be novel and the elements characteristic of the invention are set forth with particularity in the appended claims. The figures are for illustration purposes only and are not drawn to scale. The disclosure itself, however, both as to organization and method of operation, can best be understood by reference to the description of the preferred embodiment(s) which follows, taken in conjunction with the accompanying drawings in which:

FIG. 1 illustrates a mobile active decoy system (MADS) over a landscape terrain in an environment according to the disclosed embodiments.

FIG. 2 illustrates a block diagram of the components within the MADS according to the disclosed embodiments.

FIG. 3 illustrates an example LiDAR system for use with data reconnaissance sensors according to the disclosed embodiments.

FIG. 4 illustrates a flow diagram of an example of image adjustment performed by a data processing system according to the disclosed embodiments.

FIG. 5 illustrates examples of MADS implementations according to the disclosed embodiments.

FIG. 6 illustrates an example of the process flow by which the MADS would be employed to obfuscate the visual surveillance of an adversary according to the disclosed embodiments.

### DETAILED DESCRIPTION OF THE INVENTION

The embodiments of the present disclosure can comprise, consist of, and consist essentially of the features and/or steps described herein, as well as any of the additional or optional ingredients, components, steps, or limitations described herein or would otherwise be appreciated by one of skill in the art.

Before explaining at least one embodiment of the inventive concepts disclosed herein in detail, it is to be understood that the inventive concepts are not limited in their application to the details of construction and the arrangement of the components or steps or methodologies set forth in the following description or illustrated in the drawings. In the following detailed description of the embodiments of the inventive concepts, numerous specific details are set forth in order to provide a more thorough understanding of the inventive concepts. It will be apparent to one skilled in the art, however, having the benefit of the instant disclosure that the inventive concepts disclosed herein may be practiced without these specific details.

As used herein, a letter following a reference numeral is intended to reference an embodiment of the feature or element that may be similar, but not necessarily identical, to a previously described element or feature bearing the same reference numeral, such as 1, 1a, or 1b. Such shorthand notations are used for purposes of convenience only, and should not be construed to limit the inventive concepts disclosed herein in any way unless expressly stated to the contrary.

Moreover, unless expressly stated to the contrary, “or” refers to an inclusive or and not to an exclusive or. For example, a condition A or B is satisfied by anyone of the following: A is true (or present) and B is false (or not present), A is false (or not present) and B is true (or present), and both A and B are true (or present).

In addition, use of the “a” or “an” are employed to describe elements and components of embodiments of the instant inventive concepts. This is done merely for convenience and to give a general sense of the inventive concepts, and “a” and “an” are intended to include one or at least one and the singular also includes plural unless it is obvious that it is meant otherwise. It will be further understood that the terms “comprises” or “comprising,” when used in this specification, specify the presence of stated features, integers, steps, operations, elements, or components, but do not preclude the presence or addition of one or more other features, integers, steps, operations, elements, components, and/or groups thereof.

As used herein, any reference to “one embodiment,” “alternative embodiments,” or “some embodiments” means that particular element, feature, structure, or characteristic described in connection with the embodiment is included in at least one embodiment of the inventive concepts disclosed herein. The appearances of the phrase “in some embodiments” in various places in the specification are not necessarily all referring to the same embodiment, and embodiments of the inventive concepts disclosed may include one or more of the features expressly described or inherently present herein, or any combination or sub-combination of two or more such features, along with any other features that may not necessarily be expressly described or inherently present in the instant disclosure.

The inventive concepts may be described with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

The flowchart and block diagrams in the figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams or flowchart illustration, and combinations of blocks in the block diagrams or flowchart illustration, can be implemented by special purpose hardware-based systems that perform the specified functions or acts, or combinations of special purpose hardware and computer instructions.

Inventive concepts may be implemented as a computer process, a computing system or as an article of manufacture such as a computer program product of computer readable media. The computer program product may be a computer storage medium readable by a computer system and encoding computer program instructions for executing a computer process. When accessed, the instructions cause a processor to enable other components to perform the functions disclosed below.

The present disclosure is directed to a mobile active decoy system that creates an architecture that is used to deceive an adversary that depends on surveillance for data gathering. Imaging and location data is sensed, the information is processed, and then the data is projected back onto the same area to create a digital camouflage. At a high level, the system would be positioned vertically over a physical area of interest. The system provides obfuscation using the disclosed processes to the area of interest. The disclosed embodiments may observe the physical area, process the information, and project additional data down to that physical area to confuse or adjust the observable scene.

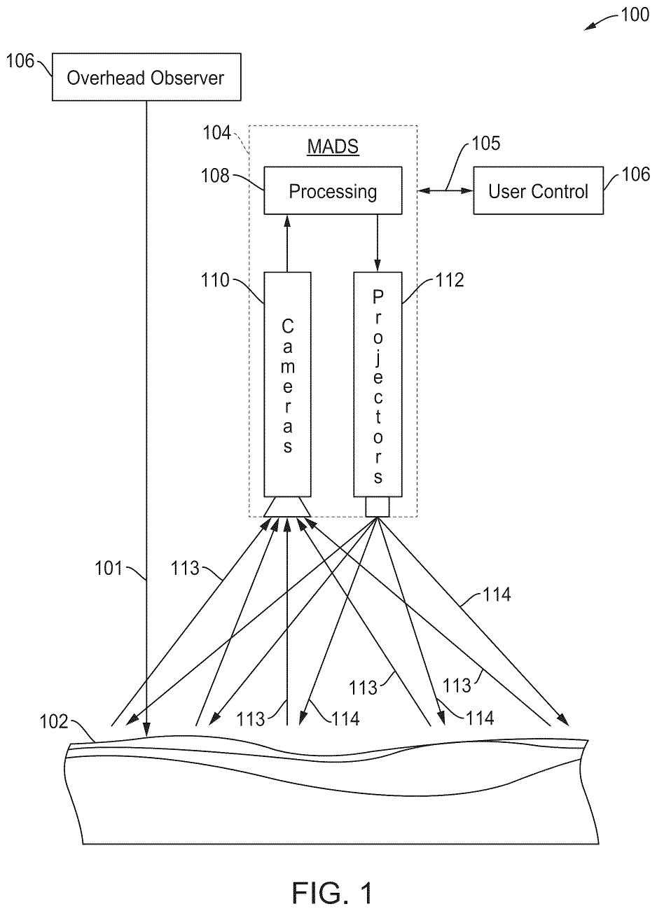

FIG. 1 depicts a mobile active decoy system (MADS) 104 over a landscape terrain 102 in an environment 100 according to the disclosed embodiments. MADS 104 is located above terrain 102 and may cover an area of the landscape in which to capture information and to provide obfuscation to other entities monitoring terrain 102. MADS 104 includes a processing system 108, which includes components disclosed in greater detail below.

MADS 104 receives a command signal 105 from user control 106. MADS 104 then may collect information using cameras 110 and other sensors deployed thereon. Cameras 110 may capture data 113, such as visual, thermal, electromagnetic, sound, and other forms of data from terrain 102 and environment 100. Camera 110 may provide the data to processing system 108. Processing system 108, in turn, may provide this information to user control 106.

User control 106 then may use commands 105 to implement an obfuscation operation using projection system 112. Processing system 108 takes a desired image or projection and combines that with the captured terrain information provided by data 113 such that an image projected from projection system 112 to overlap the image or projection onto terrain 102 in manner that may be recognizable 101 by overhead observation 109. Alternatively, MADS 104 may be configured to capture data 113 at specified times or when it detects an event that requires action on behalf of the MADS.

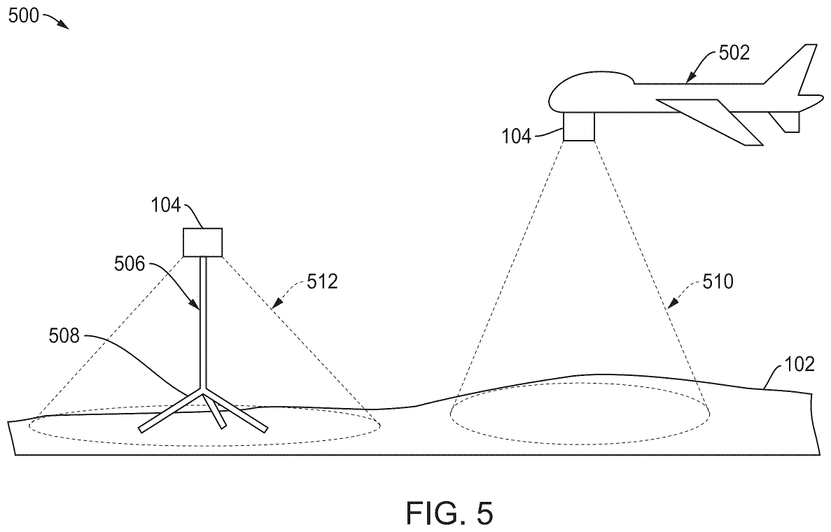

MADS 104 preferably is at an elevated position above the terrain 102, such as on a drone that hovers in the vicinity or mounted on a mast/pole the provides vertical distance from the terrain. Examples of these embodiments are disclosed by FIG. 5. MADS 104 projects the images and desired projections downwards within environment 100. User control 106 may instruct MADS 104 what to project within environment 100 using commands 105. Alternatively, processing system 108 may select a number of images or projections to overlay onto terrain 102. Processing system 108 may observe the situation within environment 100 and decide on how to proceed using intelligence or smart technologies.

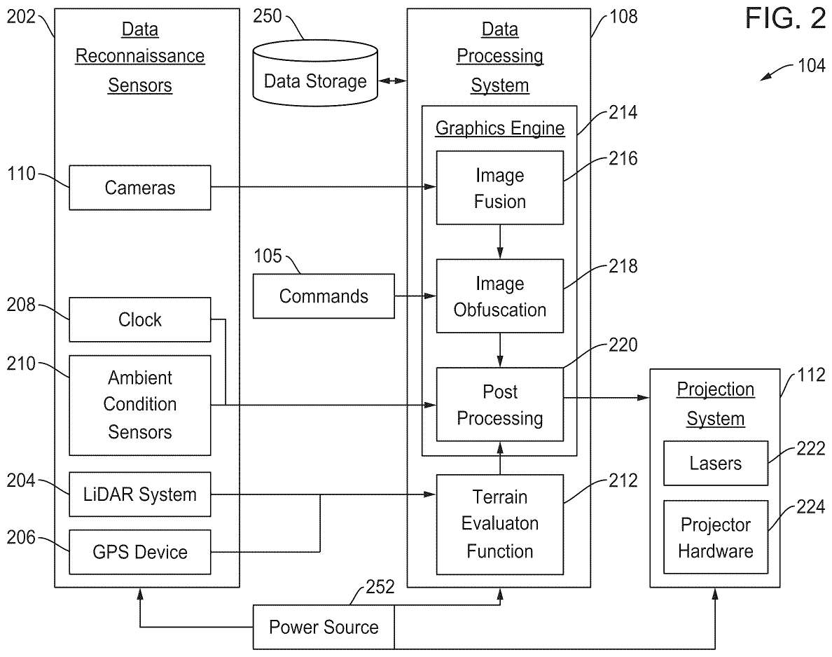

FIG. 2 is a block diagram of the components within MADS 104 according to the disclosed embodiments. As shown, MADS 104 may include three functional elements. Data reconnaissance sensors 202 includes cameras 110 along with other components that capture information and data about terrain 102 and environment 100. MADS 104 also includes data processing system 108 that interprets the data collected by data reconnaissance sensors 202. Data processing system 108 also receives user commands 105 and produces altered image data.

MADS 104 also includes projection system 112 that may include components capable of projecting images or other data in long and short infrared bands, visual spectrums, and hyperspectral bands, such as ultraviolet. With these elements, MADS 104 may observe the area of interest, such as terrain 102 and environment 100, and then project overlaying image data into terrain 102 that is observable to another entity, such as an adversary, thereby resulting in the deterioration of their gathered intelligence.

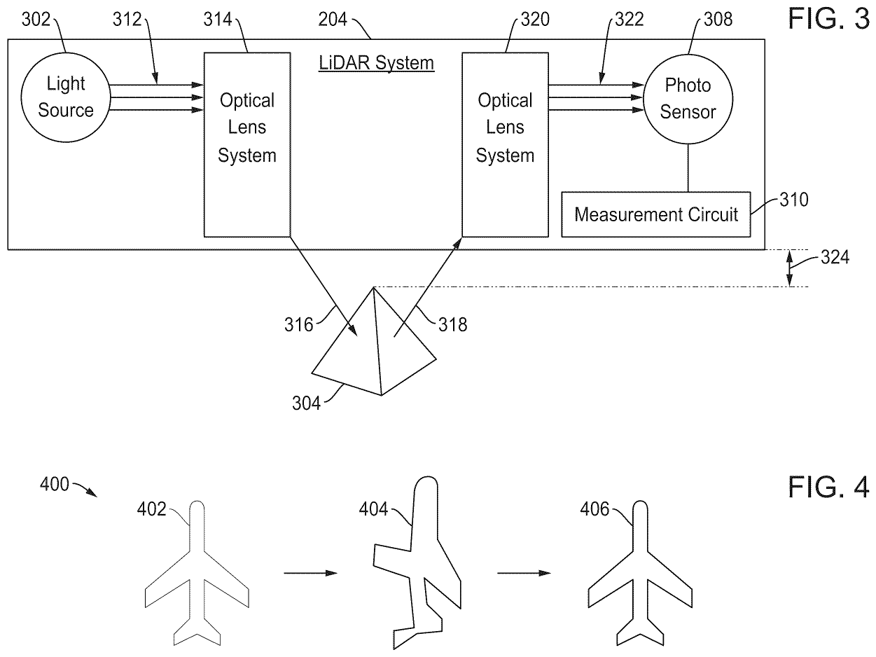

Data reconnaissance sensors 202 include a laser-imaging, detection and ranging (LiDAR) terrain scan system 204. An example LiDAR system 204 may be disclosed by FIG. 3. The LiDAR scan system 204 includes an invisible laser light source 302 that is used to accurately measure the distance from a point source to a remote surface 304. In some embodiments, LiDAR system 204 may use a combination of light source 302, photo sensor 308, and a time and phase measurement circuit 310. The LiDAR system 204 scans terrain 102 to determine topology and item features within environment 100.

Light source 302 emits signals 312 to optical lens system 314. Optical lens system 314 bends signals 312 to focus them to transmit reference light 316 in the direction of remote surface 304. Remote surface 304 returns reflected light 318 to LiDAR system 204. LiDAR system 204 includes optical lens system 320 that refracts reflected light 318 into signals 322 that are captured by photo sensor 308. The information collected by photo sensor 308 may be fed into time and phase measurement circuit 310.

The time recorded from the emission of referenced light 316 to the reception of reflected light 318 is determined by LiDAR system 204. The time recorded is used to determine a measured distance 324 based on the speed of light. Measured distance 324 may be the distance from LiDAR system 204 to remote surface 304. Many distance measurements may be collected in rapid succession, organized, and used to recreate topographical rendering of remote surface 304.

In some embodiments, LiDAR system 204 is used to scan a landscape, such as terrain 102, and provide the data necessary to recreate a digital model of the scanned area. As may be appreciated, a number of referenced light signals may be emitted to different surface points on remote surface 304 to determine the measured distance to the different surface points. Using this data, processes may be employed to identify vehicles, buildings, and the like, which have consistent profiles. It also may be used to locate vegetation that is characterized by inconsistent measurements due to many branches and leaves, which also changes over time/seasons. LiDAR system 204 also may be used in environmental conditions such as dust, fog, and a lack of ambient light.

Referring back to FIG. 2, data reconnaissance sensors 202 include global positioning system (GPS) device 206. GPS device 206 may receive and transmit data with the Global Positioning System. The Global Positioning System is a navigation system using satellites, GPS device 206 and processes to synchronize location, velocity, and time data for MADS 104. GPS device 206 may receive signals from the satellites in the Global Positioning System, which is situated near the earth's surface in MADS 104. GPS device 206 provides information on the position of MADS 104.

Data reconnaissance sensors 202 also include multi-spectral cameras 110. Cameras 110 may record information within environment. These cameras may observe the infrared, visible light, and ultraviolet spectrums. Cameras 110 may include processing and memory devices to record the data captured. Sensors 202 also include a clock 208 that provides a time signature for data collected by MADS 104. Ambient condition sensors 210 may collect information on environment 100, such as temperature, humidity, wind speed, and the like.

Data processing system 108 may receive the data and information collected by data reconnaissance sensors 202 and process the data according to the disclosed embodiments. Data processing system 108 includes a terrain evaluation function 212 and a graphics engine 214 that performs image fusion, obfuscation, and then post processing. Terrain evaluation function 212 uses data from GPS device 206 and LiDAR system 204 to evaluate terrain 102 surrounding MADS 104.

Terrain evaluation function 212 may include models or other processes that evaluate the data from LiDAR system 204 and GPS device 206 to identify landscape topology and nearby pertinent features. Features like terrain relative height and curvature would be used to assist in the decoy image modification disclosed below. The models may be trained to identify features such as vehicles, buildings, brush/trees, roads, and the like. Data from LiDAR system 204 may be fed into the models, which provide predictions on whether these features are present in environment 100. If so, then data processing system 108 may indicate that these features are present.

Graphics engine 214 includes image fusion module 216, image obfuscation module 218, and post processing module 220. In image fusion model 216, each image sensor, or camera 110, would collect and provide its own data to graphics engine 214. Each visual datapoint may include a luminance value for each spectrum recorded. For example, the disclosed embodiments may provide a longwave infrared luminance value, a shortwave infrared luminance value, a visible spectrum red luminance value, a visible spectrum green value, a visible spectrum blue value, an ultraviolet luminance value, and the like. These streams of data may be combined and overlaid so that all of the same XYZ locations are in a consistent location such that when obfuscation occurs, that it being created with the proper “view.”

Image fusion module 216 also may receive a geographic location in the X, Y, and Z planes referenced to the GPS location provided by GPS device 206 and time when an image was taken provided by clock 208. Image fusion module 216 then may create an image, or data representation, of the existing terrain as detected by MADS 104. This information is provided to image obfuscation module 218. Image obfuscation module 218 may receive operator commands 105 and generate an image, or data representation, of one or more features to overlay on the terrain image generated using terrain evaluation function 212 and image fusion module 216. Commands 105 may instruct image obfuscation module 218 what features to add or change in the scene of terrain 102. In a combat deployment example, heat signatures of friendly units recorded by data reconnaissance sensors 202 of MADS 104 may be hidden by overlaying a depiction of a much larger, irregularly shaped, or misleading patterned infrared object in the obfuscation module 218.

Post processing module 220 receives the information from terrain evaluation function 212 and image obfuscation module 218 to create an altered image data such that an image projected from MADS 104 would overlay into the surrounding environment 100 in a manner that is recognizable by overhead observers 109 such as a satellite, UAV, drone, and the like. Post processing module 220 may perform the following image modifications depending on commands 105 from user control 106.

Data processing system 108 may perform a camouflage operation that overlays additional, misleading information to an existing observable region. The feature of this process is to mask critical data from an observer. For example, MADS 104 may add thermal signatures to an observed area to make people look like a rectangular building as a method to camouflage personnel on terrain 102. In this example, the landscape of terrain 102 is observed and an input image is generated from data reconnaissance sensors 202. Data processing system 108 uses the input image and receives commands 105 to overlay an image of a building on the terrain. The image data is post processed to overlay the buildings onto terrain 102 to cover the personnel. The data to project is provided to projection system 112.

In other embodiments, data processing system 108 may perform a misdirection operation that projects false signatures, such as visual, thermal, and the like, to disguise the count or position of groups, personnel, or domestic forces. For example, many false thermal signatures may be projected onto terrain 102 which contains only an empty field to make the field appear full of personnel. Further, critical equipment or infrastructure may be cloaked with false signatures to convey damage or the lack thereof. Holes or breaks projected into critical assets to trick observers to misunderstand the operational status or critical details on the situation or items within environment 100.

In some embodiments, data processing system 108 may perform a confusion operation by adding nonsensical features to confuse enemy tracking software and personnel, such as geometric patterns, flashing lights, strobe effects, and the like. The landscape is observed and an input image is captured by data reconnaissance sensors 202. This data is post processed to overlay features to confuse enemy image recognition.

FIG. 4 depicts a flow diagram 400 of an example of image adjustment performed by the data processing system 108 according to the disclosed embodiments. Image 402 may be the image defined by MADS 104 from commands 105. In other words, image 402 is a stored accessible by data processing system 108, such as in data storage 250. Data storage 250 may be located on MADS 104, or, alternatively, accessible over a communications link to MADS 104. For example, image 402 may be an aircraft.

Graphics engine 214 applies the data and information provided by data reconnaissance sensors 202 and the data generated by terrain evaluation function 212 to generate adjusted image 404. Adjusted image 404 reflects how the image would look as is based on the terrain data from terrain evaluation function 212 and as would be projected by a point source such as the MADS 104. As can be appreciated, image 402 is altered considerably to be unrecognizable to an observer. Overlaying image 402 would cause it to look distorted. Thus, post processing module 220 modifies image 402 to adjust for the terrain data to generate decoy image 406. Decoy image 406 will include data points to adjust the data of image 402 to look like the desired feature when projected onto terrain 102 as observed from overhead 101.

Referring back to FIG. 2, decoy image 406 is provided to projection system 112. Projection system 112 includes lasers 222 and projector hardware 224. Lasers 222 may include one or more infrared, visible, and ultraviolet lasers positioned over environment 100. Projector hardware 224 may implement a variety of different technologies to display stationary or moving images onto terrain 102. Projector hardware 224 may include a liquid crystal display projector, a digital light processing projector, and the like. Lasers 222 may be used as light sources for the projectors or used as projectors themselves. Projection system 112 may utilize infrared, visible spectrum, and ultraviolet light sources, such as lasers 222, to project the post processed image, such as decoy image 406, onto terrain 102.

MADS 104 also may include power source 252. Power source 252 may provide power to the components of MADS 104 disclosed in FIG. 2 as well as propulsion systems and other components normally associated with flying platforms. Power source 252 may be a self-contained power source in the form of a generator or solar panel and battery system. In some embodiments, power source 252 may be a power cable as a permanent power source, if available.

FIG. 5 depicts a configuration of an array 500 using multiple MADS according to the disclosed embodiments. Two MADS platforms may be deployed over terrain 102. One platform may include overhead UAV 502, which may fly or hover over terrain 102. MADS 104 may be positioned on UAV 502 to scan area 510 using LiDAR system 204. Data reconnaissance sensors 202 also collects data and information within area 510. Projection system 112 projects the image or images to confuse an observer within area 510.

Another platform may be mast 506. MADS 104 for mast 506 may be positioned on top of the mast. Mast 506 includes a mast base 508, which is within area 512 that is scanned for terrain 102 as disclosed above. MADS 104 for mast 506 also must account for mast base 508 when projecting one or more images within area 512. A projected image, such as decoy image 406, would be projected down upon mast 506 and mast base 508. Through image rendering computations, the geometry of mast 506 and mast base 508 may be determined as it relates to terrain 102. The image adjustment by graphics engine 214 would be made to conceal mast 506 in the resulting projected image. Mast 506 may be constructed with a matte finish so as to not reflect the projected light in an undesirable manner.

In some embodiments, MADS 104 using mast 506 may have difficulty in implementing a process whether projection system 112 is concealed by the projected image. Thus, the projected images from MADS 104 of mast 506 may have some small artifact in the middle of the projection caused by viewing the MADS hardware above the image itself. Reducing the size of the MADS hardware package may increase the mobility of MADS 104 as a deployable system but it also reduces the potential for MADS 104 to create an artifact in the resulting image when used on mast 506. Use of MADS 104 on UAV 502 may not provide this feature.

MADS 104 of UAV 502 and MADS 104 of mast 506 may be configured to be used in conjunction with each other as a system to provide obfuscation operations over terrain 102. GPS data by the GPS device 206 of each MADS 104 may be used to define an understanding of the relative position of UAV 502 and mast 506. For example, UAV 502 would know where mast 506 is located. With this information, MADS 104 of UAV 502 and MADS 104 of mast 506 may be grouped together to create an image area that includes areas 510 and 512. Thus, for example, rather than projecting a single battle tank by one MADS 104, multiple MADS may be used in conjunction with each other to project images of multiple tanks and larger structures like buildings, aircraft, and the like.

User control 106 may be used to coordinate the position of UAV 502 in relation to mast 506. Alternatively, MADS 104 of UAV 502 and MADS 104 of mast 506 may communicate with each other and provide GPS data collected by the respective GPS devices 206. MADS 104 of UAV 502, for example, may determine a standoff distance from mast 506 based on instructions stored in data storage 250 or provided by commands 105. It is also understood that the array of MADS 104 implementations are not restricted to just a combination of a mast 506 and UAV 502 implementations. Instead, numerous combinations of either the mast 506 or UAV 502 may be used to create the desired decoy effect.

The disclosed embodiments present MADS 104 as a completely packaged solution. It may be appreciated that the major elements of MADS 104 may be distributed. For example, stationary-mounted cameras at a base or even old satellite data may be used for data reconnaissance sensors 202. The processing operations of data processing system 108 may occur in a data center, portable computing device, and the like. Projection system 112 may be a high energy ground-based light source that generates the light that is sent through light-guides up to a small optics head to project the image to the desired area.

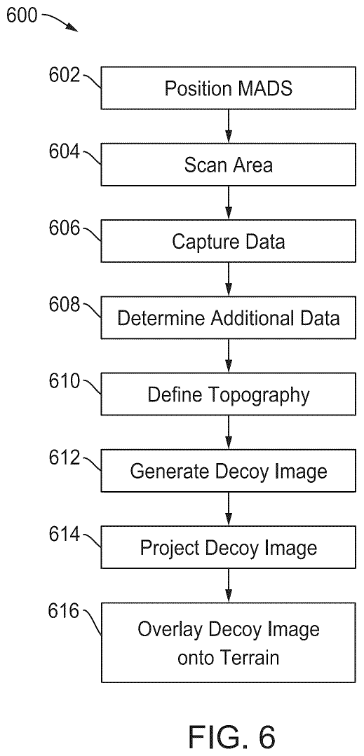

FIG. 6 depicts a flowchart 600 for performing visual obfuscation of terrain 102 according to the disclosed embodiments. Flowchart 600 may refer to FIGS. 1-5 for illustrative purposes. Flowchart 600, however, is not limited to the embodiments disclosed by FIGS. 1-5.

Step 602 executes by positioning MADS 104 above an area, such as area 510, of terrain 102. MADS 104 may be guided using a propulsion system such as UAV 502. Alternatively, MADS 104 may be placed in a fixed position, such as with mast 506. Step 604 executes by scanning the area of terrain 102 using LiDAR system 204, as disclosed above. LiDAR system 204 may capture topography data based on the results of the scan. Step 606 executes by capturing infrared, visual, or ultraviolet images or data within the area using cameras 110.

Step 608 executes by determining additional data for terrain 102 and the corresponding area using other components of data reconnaissance sensors 202. For example, GPS device 206 may receive data to determine a location of MADS 104. Clock 208 may provide a time and date for data coming into MADS 104. Ambient condition sensors 210 may capture data about the temperature, humidity, and the like about the area under surveillance by MADS 104.

Step 610 executes by defining a topography of terrain 102 using terrain evaluation function 212 based on the data scanned by LiDAR system 204. Step 612 executes be generating decoy image 406 using graphics engine 214 of MADS 104. This process is disclosed above. The topography from terrain evaluation function 212 and data collected from GPS device 206, cameras 110, clock 208, and ambient condition sensors 210 along with commands 105 help determine an image to overlay on terrain 102 and adjust it to fit the contours of terrain 102.

Step 614 executes by projecting decoy image 406 into the area below MADS 104 using projection system 112. Projector hardware 224 and one or more lasers 222 are used to generate decoy image 406. Step 616 executes by overlaying decoy image 406 onto terrain 102 so as to obfuscate the features of the terrain from observation by another entity also positioned above the area of terrain 102. In some embodiments, steps 614 and 616 are executed as one step.

While the present disclosure has been particularly described, in conjunction with specific preferred embodiments, it is evident that many alternatives, modifications and variations will be apparent to those skilled in the art in light of the foregoing description. It is therefore contemplated that the appended claims will embrace any such alternatives, modifications and variations as falling within the true scope and spirit of the present disclosure.

What is claimed is:

1. A mobile active decoy system (MADS) comprising:
a laser-imaging, detection and ranging (LiDAR) system to scan an area of a terrain to capture topography data;
at least one camera to capture data of at least one feature within the area;
a terrain evaluation function to define a topography of the terrain using the topography data;
a graphics engine to generate a decoy image using the topography of the terrain and the data of the at least one feature; and
a projection system to project and overlay the decoy image onto the area of the terrain.

2. The MADS of claim 1, wherein the graphics engine includes an image fusion module to receive data from the at least one camera to generate an image of the terrain.

3. The MADS of claim 2, wherein the graphics engine includes an image obfuscation module to receive a command to generate a user defined image.

4. The MADS of claim 3, wherein the graphics engine includes a post processing module to generate the decoy image based on the user defined image and the image of the terrain.

5. The MADS of claim 1, further comprising a global positioning system (GPS) device to capture GPS location data to provide to the graphics engine.

6. The MADS of claim 1, wherein the at least one camera includes an infrared spectrum camera.

7. The MADS of claim 1, wherein the at least one camera includes a visible light spectrum camera.

8. The MADS of claim 1, wherein the at least one camera includes an ultraviolet spectrum camera.

9. The MADS of claim 1, wherein the projection system includes at least one light source.

10. The MADS of claim 9, wherein the at least one light source is a laser.

11. The MADS of claim 1, further comprising at least one ambient condition sensor to capture data of an environment related to the terrain and to provide the data of the environment to the graphics engine.

12. The MADS of claim 1, further comprising a mast to position the MADS above the terrain.

13. A mobile active decoy system (MADS) configuration comprising:
a first MADS platform having a first MADS, wherein the first MADS includes
a laser-imaging, detection and ranging (LiDAR) system to scan a first area of a terrain to capture topography data,
at least one camera to capture data of at least one feature within the first area,
a terrain evaluation function to define a topography of the terrain within the first area using the topography data,
a graphics engine to generate a first decoy image using the topography of the terrain and the data of the at least one feature, and
a projection system to project and overlay the first decoy image onto the first area of the terrain; and
a second MADS platform having a second MADS, wherein the second MADS includes
a LiDAR system to scan a second area of the terrain to capture topography data, wherein the second area is not located within the first area,
at least one camera to capture data of at least one feature within the second area,
a terrain evaluation function to define a topography of the terrain within the second area using the topography data,
a graphics engine to generate a second decoy image using the topography of the terrain and the data of the at least one feature, and
a projection system to project and overlay the second decoy image onto the second area of the terrain.

14. The MADS configuration of claim 13, wherein the first decoy image and the second decoy image are positioned to not overlay each other.

15. The MADS configuration of claim 13, wherein the first MADS platform or the second MADS platform is an unmanned aerial vehicle (UAV).

16. The MADS configuration of claim 13, wherein the first MADS platform or the second MADS platform includes a mast.

17. The MADS configuration of claim 13, wherein the first MADS platform includes a global positioning system (GPS) device.

18. The MADS configuration of claim 17, wherein the second MADS platform includes a GPS device, such that the first MADS platform is positioned away from the second MADS platform based on data from the GPS device of the second MADS platform.

19. A method for performing visual obfuscation of a terrain, the method comprising:
scanning an area of the terrain using a laser-imaging, detection and ranging (LiDAR) system of a mobile active decoy system (MADS) positioned above the area of the terrain to capture topography data of the area;
capturing data of at least one feature of the area using at least one camera of the MADS;
defining a topography of the terrain within the area using a terrain evaluation function of the MADS and the topography data;
generating a decoy image using a graphics engine of the MADS based on a user defined image, wherein the graphics engine receives the topography of the terrain and the captured data of the at least one feature to adjust the user defined image to generate the decoy image;
projecting the decoy image from a projection system of the MADS to overlay the decoy image onto the terrain, wherein the decoy image obfuscates the terrain.

20. The method of claim 19, further comprising collecting ambient condition data for the area using sensors of the MADS.
